(19) United States
(12) Patent Application Publication
(10) Pub. No.: US 2003/0114208 A1
(43) Pub. Date: Jun. 19, 2003

(54) Video slot gaming machine using light-pen technology in the form of a bow-and-arrow or arcade-style gun for the second-screen bonus game

(76) Inventor: Nir Yehuda Lorant, San Luis Obispo, CA (US)

Correspondence Address: Nir Y. Lorant, MD, 2040 Broad St., Ste B, San Luis Obispo, CA, 93401, US

(21) Appl. No.: 09/884,339

(22) Filed: Dec. 19, 2001

(51) Int. Cl. A63F 13/00

(52) U.S. Cl. 463/7

(57) ABSTRACT

This is a Video Slot Gaming Machine with the differentiation from other gaming devices in that this machine uses light-technology in the form of a bow and arrow or an arcade-style light gun for the second-screen bonus game.

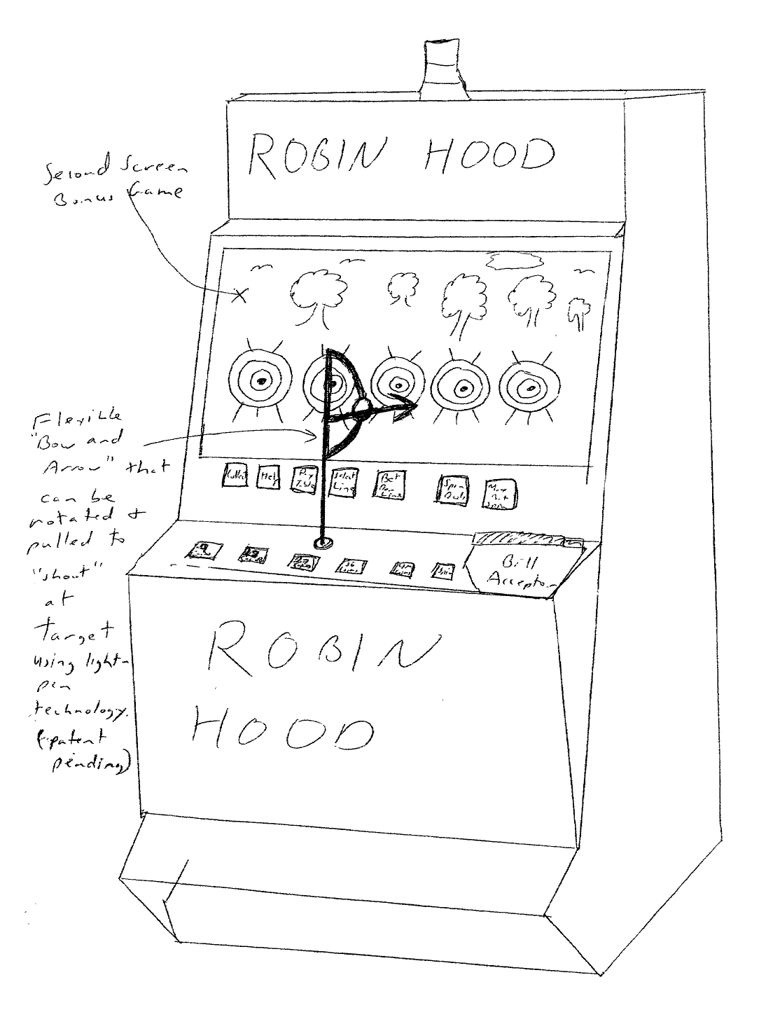

A flexible yet rigid “bow and arrow” structure that is attached to the game front control panel is used during the bonus game. The “arrow” is attached to the “bow”, but it sits in a loop allowing the player to draw it back and release it. Once released, a computer generated “arrow” flies into the screen and towards a target. A bonus amount is then awarded the player.

For the arcade-style gun, the player “shoots” into the computer monitor and credits are awarded for hitting various targets.

No current Video Gambling machines use this type of player interaction for the second screen bonus game.

This is a 5-reel, 9-line gaming machine, with the prototype based on the Robin Hood theme. The main distinguishing feature of this game being that the second screen bonus requires the use of a miniature light-emitting bow and arrow, or in future applications an arcade style light-emitting gun.

Primary game reel symbols range from Robin Hood (five on a lit payline win the game's top jackpot of 5,000 coins times the amount bet per line) to Maid Marion, Friar Tuck, a forest scene, a bag of gold, Sheriff of Nottingham, a rich man and a poor man. There is a scatter-pay symbol, the words “Merry Men”, which pays 3 coins, 15 coins and 125 coins times the total bet for three, four, or five, respectively, anywhere on the screen.

Three or more “target” symbols lined up on an active payline trigger the unique second screen bonus event. The screen transforms into an open field scene with five targets at a distance. The player is then prompted to point and “shoot” an arrow at one of the five targets. This is accomplished by using a flexible yet rigid “bow and arrow” structure that is attached to the game front control panel. The “arrow” is attached to the “bow”, but it sits in a loop allowing the player to draw it back and release it. The light-emitting “arrow” will allow the computer to determine that this action has been accomplished, and in which general direction the “arrow” should fly. When the player releases the bow, the arrow appears to fly into the screen and at the appropriate target that the player chose. The number of targets that the player has a chance to shoot at is determined by the number of target symbols obtained at the primary screen. Whether the player obtains a bulls eye or some other score is predetermined by the RNG. The better the hit on the target, the more credits won.

Below is a drawing of the machine with the bow and arrow set-up, and the characters and their credit values.

| | 5 | 4 | 3 | 2 | |
|---|---|---|---|---|---|
| Robin Hood | 5,000 | 700 | 200 | 10 | 2 |
| Maid Marion | 1,500 | 350 | 50 | 7 | — |
| Friar Tuck | 120 | 60 | 15 | 4 | — |
| Forest | 100 | 50 | 10 | 7 | — |
| Bag of Gold | 100 | 40 | 7 | — | — |
| Sheriff of | 80 | 30 | 7 | — | — |
| Nottingham | | | | | |
| Rich Man | 70 | 20 | 5 | — | — |
| Poor Man | 70 | 20 | 5 | — | — |
| “Merry Men” | | | | | |
| Scatter(× total | 125 | 15 | 3 | — | — |
| bet) | | | | | |

Target - three targets = two shots, four targets = three shots, and five targets = four shots

1. What I claim as my invention is an interactive “bow and arrow” or arcade style “light gun” structure on the front panel of a gambling machine that interact with the screen by “shooting” at objects within the screen after the player has reached the second-screen bonus game.
